(19) United States
(12) Patent Application Publication
(10) Pub. No.: US 2007/0112651 A1
(43) Pub. Date: May 17, 2007

(54) APPARATUS AND METHOD FOR ANALYZING OUT OF STOCK CONDITIONS

(75) Inventors: Richard James Swan, Portola Valley, CA (US); Jonathan Golovin, Atherton, CA (US)

Correspondence Address: COOLEY GODWARD KRONISH LLP, 3000 EL CAMINO REAL, 5 PALO ALTO SQUARE, PALO ALTO, CA, 94306, US

(73) Assignee: T3C INC., Mountain View, CA (US)

(21) Appl. No.: 11/551,689

(22) Filed: Oct. 20, 2006

Related U.S. Application Data
(60) Provisional application No. 60/729,001, filed on Oct. 20, 2005.

(51) Int. Cl. G06Q 10/00

(52) U.S. Cl. 705/28

(57) ABSTRACT

A method of evaluating out of stock conditions includes determining a minimum provable stock level relying upon RFID and non-RFID information sources.

### CROSS REFERENCE TO RELATED APPLICATIONS

This application claims the benefit of U.S. Provisional Application Ser. No. 60/729,001, entitled “Apparatus And Method For Analyzing Out Of Stock Conditions,” filed Oct. 20, 2005, the contents of which are hereby incorporated by reference in their entirety.

### BRIEF DESCRIPTION OF THE INVENTION

This invention relates generally to the distribution and sale of retail items. More particularly, this invention relates to techniques for retrospectively analyzing out of stock conditions using traditional data sources and RFID data sources.

### BACKGROUND OF THE INVENTION

Periodically, retailers and major vendors use human auditors to physically check shelves for out-of-stock conditions. Typically the auditors identify appropriate shelf labels and if the shelf is empty (out-of-stock) the shelf tag is read electronically. Later this shelf tag read data is married with information from the store systems, such as the reported store inventory, shelf quantities, last POS (point of sale) transaction, etc. This OOS (out-of-stock) audit report is then available for analysis.

A typical analysis approach, used in prior art, is to simply report the count of reported OOS events over the time period of the audit, leading to an overall OOS rate that is calculated by dividing the count by the number of days. However, this can lead to a substantial under reporting of the true OOS incidence as would be experienced by shoppers. It also tends to obscure the underlying causes of OOS and thus inhibits the opportunity to take appropriate measures to reduce OOS.

The under reporting comes from the auditors sometimes missing empty shelf positions. This may come from shelf stock “filling in” around an empty position so that it is hard to spot, from a shelf label missing, from haste or other human factors.

Consider a stock situation based upon the following information in Table I blow.

TABLE I

| ITEM_NBR | PI_ONHAND_QTY | SCAN_TIMESTAMP | LAST_POS_TIMESTAMP |
|---|---|---|---|
| 268762 | 12 | 3/1/2005 14:00 | 3/1/05 8:00 |
| 268762 | 12 | 3/2/2005 14:00 | 3/1/05 8:00 |
| 268762 | 12 | 3/6/2005 14:00 | 3/1/05 8:00 |
| 268762 | 12 | 3/8/2005 14:00 | 3/1/05 8:00 |

In this OOS audit report each table entry represents one report from the auditors. The Scan_timestamp column is the time the shelf tag was scanned after the auditor noticed the OOS condition. The Last POS Timestamp is the indication from the store inventory system as to when the last sale of this product was made. The PI On Hand Qty is the Perpetual Inventory believed to be in the store according to the store's inventory system.

Suppose that the total length of the audit trial is 100 days. A conventional analysis would count 4 reports of OOS, divide this by the total duration (100) leading to an OOS rate of 4%. This coarse conventional analysis potentially underreports actual OOS conditions. Accordingly, it would be desirable to provide improved techniques for analyzing OOS conditions.

### SUMMARY OF THE INVENTION

The invention includes a method of evaluating out of stock conditions by determining a minimum provable stock level relying upon RFID and non-RFID information sources.

### BRIEF DESCRIPTION OF THE FIGURES

The invention is more fully appreciated in connection with the following detailed description taken in conjunction with the accompanying drawings, in which:

FIG. 1 illustrates a computer configured in accordance with an embodiment of the invention.

FIG. 2 illustrates a table of OOS episodes as a function of frequency and duration, as constructed in accordance with an embodiment of the invention.

Like reference numerals refer to corresponding parts throughout the several views of the drawings.

### DETAILED DESCRIPTION OF THE INVENTION

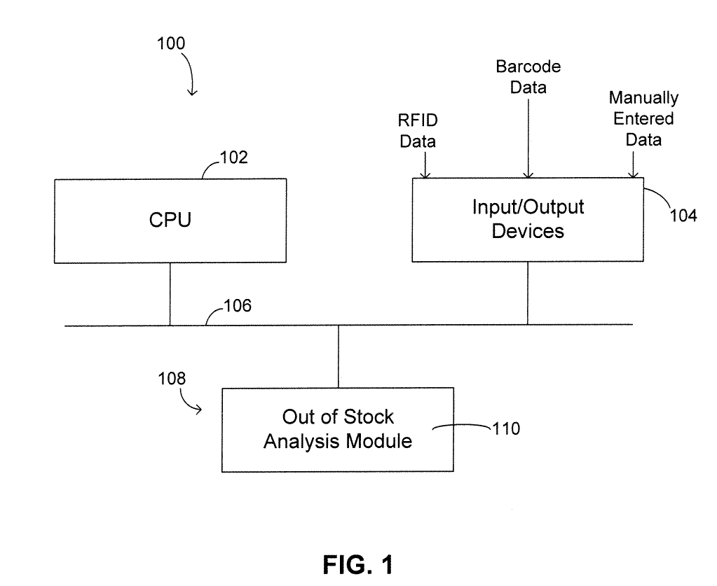

FIG. 1 illustrates a computer 100 configured in accordance with an embodiment of the invention. The computer 100 includes standard components such as a central processing unit 102 connected to a set of input/output devices 104 via a bus 106. The input/output devices include a keyboard, mouse, monitor, printer, and conventional interfaces to data gathering devices, such as RFID scanners and barcode scanners. Thus, as shown in FIG. 1, the input/output devices 104 receive RFID data, barcode data, and manually entered data related to retail stock conditions.

Also connected to the bus 106 is a memory 108. The memory stores executable instructions to implement operations associated with the invention. In particular, the memory stores an OOS analysis module 110, which includes executable instructions to implement the processing operations discussed below.

Returning to the example associated with Table I, a closer look at the individual table entries indicates that the last actual sale was at 8 am on 3/1/2005. At the time of the first audit report, the shelf was OOS for approximately 6 hours. Since we know that for a particular retail chain that shelf replenishment often occurs at specific times, for example at an average time of 4 am each morning, the OSS analysis module 110 can compute from the first report that the store was OOS for approximately 20 hours. However, we see a subsequent report on 3/2/2005 that indicates the store was also OOS on that day. The reported last POS time remains unchanged from the first report. Thus, the OOS analysis module 110 can infer that no sales were made and that the shelf was not replenished.

The next OOS report is on 3/6/2005. Again, the last reported POS sale date and time is unchanged. Hence, while the auditor did not report OOS for 3/3/2005, 3/4/2005 and 3/5/2005, nevertheless, the OOS analysis module 110 can infer that the shelf was OOS for the gap of three days. The shelf was OOS at the beginning of the report gap, it was OSS at the end, and no sales were made in between. Hence the OOS analysis module 110 infers, based on this additional POS last transaction data that for some reason the auditors missed several days of OOS. Looking at the last entry, and assuming there are no subsequent OOS reports, the OOS analysis module 110 can infer that this product was OOS from 3/8/2005 8 am until at least the next replenishment time after 3/08/2005 14:00.

Assuming an average replenishment time of 4 am, we have a total OOS period of approximately 8 days plus 20 hours, or 212 hours. Considering a 24 hour shopping day, the effective out of stock rate is 212/(24*100)˜8.3 %. This is significantly different from the 4% OOS rate calculated by conventional analysis.

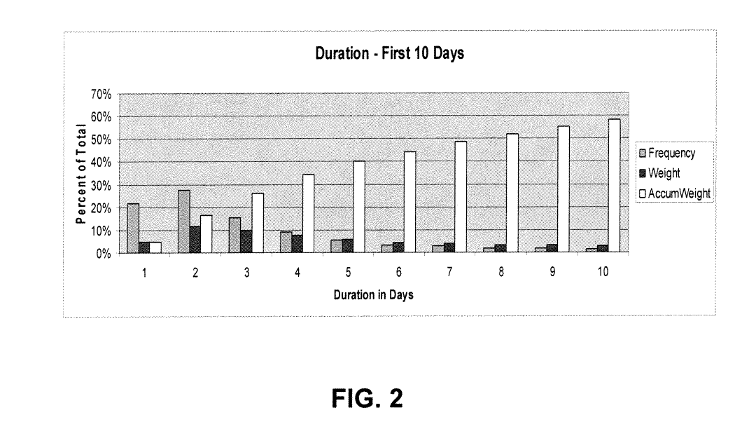

Conventional analysis of OOS looks at each daily incident of out-of-stock as an independent event. While useful for some metric purposes, this view tends to hide some of the root causes and possible interventions of OOS. In accordance with an embodiment of the invention, episodic analysis is carried out by using the available audit and other data to determine the start and end date of each “Episode” of OOS. For example, in the above table, the single episode of OOS began on 3/1/2005 at 8 am and ended at approximately 4 am on 3/9/2005. By tabulating each episode, at each store for each product it is possible, using well known techniques, to calculate a frequency table of duration of OOS episodes, such as shown in FIG. 2.

FIG. 2 illustrates a typical OOS duration frequency chart for certain major brands at a retailer. While conventional analysis might just report a certain occurrence rate of OOS, the Episodic Frequency Duration chart gives some immediate insight into reduction of OOS. In this sample data, approximately 20% of episodes last one day, while almost 30% last two days. Thus, approximately 50% of OOS episodes are short −1 to 2 days. Uncovering the root cause of the initiation of these episodes is addressed elsewhere. However, the chart also shows the weight (frequency times duration) of each episode and the accumulated weight (sum of weights starting from 1 day duration). Looking at the accumulated weight, we see that episodes of duration 1 day and 2 days only account for less than 20% of the total accumulated days of OOS. Thus, less than 20% of the shopper's experience of OOS is accounted for by short duration (1 or 2 day) episodes of OOS. In the above sample data, the accumulated weight of OOS days only reaches 50% between 7 and 8 days duration.

This analysis immediately shows that if OOS could be detected and corrected within 7 days, this would reduce by 50% the experience of OOS and significantly improve supplier and retailers profits. If OOS was detected within 48 hours, OOS could be reduced by 80%. This translates to many billions of dollars for US manufacturers and retailers.

Retrospective root cause analysis is accomplished by first assembling all the available information for the subject time period. Available information may include:

Point-Of-Sale data by day (or finer grain if available) for each product at each store.

Current On Hand inventory report by day, for each product at each store.

Order information for store deliveries from the Distribution Center for each replenishment order.

Maximum permitted Sales Floor inventory for the product at each store. (Plan-O-Gram)

Vendor Pack size (relates unit of delivery from the DC to the quantity of unit-of-sale products).

RFID derived data for deliveries to the backroom of the store and RFID data for product movements to the sales floor from the backroom. Note that this data may not be complete.

OOS Audit data

Promotion plans

Seasonal and other demand factors

Order Policy

Having assembled all the relevant data, there are a number of preliminary calculations that can be performed in accordance with the invention with one or mores passes over the data:

Statistical analysis of sales. Overall statistics may be computed on just a single product in a single store, or combining stores that are considered comparable to form an appropriate baseline. Use the POS data to calculate the mean and standard deviation of sales measured and normalized in various ways.
In order to have threshold limits that are independent of shelf capacity, sales may be normalized to units of shelf capacity. For example, if the permitted shelf capacity is 12, then measure sales in units of 12, rather than the normal individual sales units in POS.
While POS sales are normally reported on a daily basis, the time unit of interest is the overall latency, or delay between detecting a need or opportunity to order more stock for the store until the replenished product can actually be stocked on the shelf. For example, for a particular product class in a particular retailer, the order may be placed in the evening of day 1, day 2 may be used for scheduling, planning, and pulling the requested quantity at the DC, Day 3 may be used or delivery, and the product may actually reach consumer shelves in the early hours of day 4. Thus, in this example, there is a 3 day latency between (1) consumption in the store triggering replenishment and (2) actual shelf availability of new product. So when looking at the question of demand level, relative to historical levels, it is the total demand in the latency period that is of concern. One embodiment of the invention calculates the shelf-size normalized statistics for a range of possible replenishment latencies.

For each day in the time period, calculate the distance (in std) of normalized sales for that day from the overall mean sales calculated previously. This provides a normalized basis to measure demand.

The most important aspect of understanding OOS is to determine the minimum true inventory in the store. While it is not possible, without a reliable audit, to determine the total number of units in a store—these may be hidden in the backroom or on the sales floor—the following technique allows determination of the minimum quantity in the store on a retrospective basis. For a subject time period, for a single product at a single store, consider the time sequence of replenishments to the store and sales (POS) from the store. By basic conservation of product arguments, any unit reported as sold, must have been in the store at the time of sale. Either the product was in the store at the beginning of the time period (starting inventory) or it was replenished to the store during the time period. Starting with an initial provable minimum inventory level of zero (min-provable-PI), add to this value for each POS sale. Reduce this value by any provable shipment to the store. By applying this process to the entire time period, the resulting min-provable-PI will represent the net minimum inventory that must have been in the store at the beginning of the time period. If it is known that an OOS occurred during this period, then this number also represents the maximum inventory available for sale in the store.

To accurately determine the deliveries to the store, a legacy store system could report an increase in store Perpetual Inventory (PI). The actual delivery to the store may be reinforced by RFID data. Note that in some store systems that the store PI may be subject to frequent manual adjustments. Rather than use positive increases in the PI (adjusted for sales on the same day) as the quantity delivered, the preferred approach is to know the number of units per Vender Pack, and compute the most likely integral numbers of packs.

The following code may be used to implement operations associated with the invention.

Procedure

min-provable-PI = 0;
For t = 0 to n−1 {

Min-provable-PI = Min-provable-PI + Salesₜ − Deliveries ₜ

}

Where Salesₜ represents net POS sales for period t (usually 1 day).
Deliveriesₜ represents the best estimate of actual store deliveries for period t.
Deliveries are almost always made in vendor pack quantities, hence Deliveriesₜ will be an integer multiple of the number of sales units per vendor pack.

1. Retrospective OOS Root Cause Analysis

There are numerous ways to apply this process. For clarity this is expressed as a sequential review of the subject period on a period by period basis (usually one day).

The available, precomputed, values available for each record are:

isOOS(t)
This product, at this store, was OOS for period t

isInitalOOS(t)
First time period of an episode of OOS

periodsSincePossibleOrder(t)
Number of days since this product could be ordered within the rules of the replenishment model. Usually this means that the store could be replenished without overflowing the shelf or backroom stock goal.

LegacyPI(t)
Store system reported value of perpetual inventory

ProvablePI(t)
ProvablePI(0)=min-provable-PI as calculated above.
ProvablePI(t) is the time period by time period PI adjusted for sales and deliveries.

OrderRepenishmentDelay
Preset or calculated value that is the number of time periods between placing an order and the goods being available for sale.

PeriodsSinceStoreReplenishment(t)
Time since last replenishment to store

PeriodsSinceBackroomRFID(t)
Time since this product was seen via RFID at receiving door

PeriodsSinceSalesfloorRFID(t)

Time since this product was seen via RFID entering the salesfloor

// Handle reporting of period which is NOT OOS
if (!isOOS(t)) {

if (periodsSincePossibleOrder(t) > orderReplenDelay) {

setClassifcation(“CIS_2_not OOS - replenishment opportunity missed ”);

} else {

setClassifcation(“CIS_2_not_OOS - no replenishment possible”);

}
return; // reporting for non-OOS complete

}
// Handle periods which are continuations of OOS
if (isOOS(t)& ! isInitalOOS(t)) {

if ((LegacyPI(t) >0) && (ProvablePI(t)==0)) {

| | |
|---|---|
| setClassifcation(“CIS_3_Con__OOS_continuation with Wrong PI” | ); |
| return; | |

} else if (ProvablePI(t) >0) {

if ((PeriodsSinceSalesfloorRFID(t) <= PeriodsSinceReplenishment(t))) {

setClassifcation(“CIS_3_Con_OOS_continuation_T3PI > 0_Stock arrived and was
moved to SF - misplaced or stolen?”);
return;

} else
if ((PeriodsSinceBackroomRFID(t) <= PeriodsSinceReplenishment(t)) ) {

setClassifcation(“CIS_3_Con_OOS_continuation_T3PI > 0_Stock arrived but not
seen moving since SF”);
return;

} else {
setClassifcation(“CIS_3_Con_OOS_continuation with T3PI > 0 - Stock in Store);
return;
}
} else {

setClassifcation(“CIS_3_Con_OOS_continuation - not classified”);
}

return;
}

// Handle first day of OOS episode
if (initial) {

if ((LegacyPI(t) ==0) && (ProvablePI(t)==0)) {

if (daysSincePossibleOrder > orderReplenDelay) {
// goods should have been ordered and delivered
setClassifcation(“CIS_4_OOS_Initial both PI==0 - Not ordered ”);
} else {
// demand must have exceeded store level supply
setClassifcation(“CIS_4_OOS_Initial both PI==0 Excess_Demand”);
}
return;
} else if ((LegacyPI(t) > 0) && (ProvablePI(t)<=0)) {

if (periodsSincePossibleOrder > orderReplenDelay) {

// goods could still have been ordered
setClassifcation(“CIS_4_OOS_Initial Phantom Inventory but goods should
still have been ordered”);
return;
} else {

setClassifcation(“CIS_4_OOS_Initial Phantom Inventory - prevented order”);
return;
}

} else if ((LegacyPI(t) > 0) && (ProvablePI(t)>0)) {

// Product is in store - why is not available to customers?
if ((PeriodsSinceSalesfloorRFID(t) <= PeriodsSinceReplenishment(t))) {

setClassifcation(“CIS_4_OOS_Initial_T3PI > 0_Stock arrived and was

moved to SF - misplaced or stolen?”);

return;

} else if (PeriodsSinceBackroomRFID(t) <= PeriodsSinceReplen(t) ) {

setClassifcation(“CIS_4_OOS_Initial_T3PI > 0_Stock arrived but
not seen moving to SF”);
return;

} else if ((PeriodsSinceBackroomRFID(t) > daysSinceStoreReplenishment)

&& (daysSinceRFIDSF > daysSinceStoreReplenishment)) {
setClassifcation(“CIS_4_OOS_Initial_T3PI > 0_Stock not seen by

RFID - Late delivery?”);

return;

} else if ((daysSincePos < 1) ) {

// complex, mixed reported sales and reported OOS situation
setClassifcation(“CIS_4_OOS_Initial_T3PI > 0 & Sales Same Day

_possible misplaced or end cap merchandise”);

return;

} else if (daysSinceRFIDSF > 2){

// TO DO calculate numbers of days since RFID based on VNPK

and recent POS

setClassifcation(“CIS_4_OOS_Initial_T3PI > 0_No RFID,

Probable stock in backroom”);

return;

} else {
// Shelf was repelensiehd within 2 days
setClassifcation(“CIS_4_OOS_Initial_T3PI > 0_Recent RFID,not fully

classfied”);

return;

}

}

setClassifcation(“CIS_4_Initial_NOT Classified”);
return;

}

Various types of data may be processed in accordance with embodiments of the invention.

Example data sources include:

Master Data
Site information (For statistical studies)

| Site | Test_type | Store_type | RFID_enabled | Location |
|---|---|---|---|---|
| 283 | Control | Discount Ctr-EF | No | Bridge City Tx |
| 389 | Control | Discount Ctr | No | Edmond OK |
| 449 | Control | SuperCenter | No | Port Arthur Tx |
| 457 | Control | Discount Ctr | No | Vidor Tx |
| 703 | Control | SuperCenter | No | Tomball Tx |
| 2804 | Control | SuperCenter | No | Oklahoma City OK |
| 3275 | Control | Neigh_Mkt | No | Oklahoma City OK |

Item Information

| ITEM_NBR | BRAND_NBR | ITEM_TYPE | SGTIN_Prefix |
|---|---|---|---|
| 2709018 | 1 | RFID | sgtin:0080878.101272 |
| 2768662 | 2 | RFID | sgtin:0037000.166154 |
| 2808026 | 2 | RFID | sgtin:0037000.135514 |
| 2809612 | 1 | RFID | sgtin:0080878.101400 |
| 2809703 | 1 | RFID | sgtin:0080878.101418 |
| 2809794 | 1 | RFID | sgtin:0080878.101436 |
| 2817854 | 1 | RFID | sgtin:0080878.101116 |
| 2817971 | 1 | RFID | sgtin:0080878.101098 |
| 2858895 | 1 | RFID | sgtin:0080878.101656 |
| 2953795 | 2 | RFID | sgtin:0037000.167758 |
| 3083444 | 2 | RFID | sgtin:0037000.132110 |

Transactional Data

OOS Audit Data

| | UPC_{—} | ITEM_{—} | PRODUCT_{—} | PI_ONHAND_{—} | ON_ORDER_{—} | IN_WHSE_{—} | RFID_ONHAND_{—} | ORDER_TYPE_{—} |
|---|---|---|---|---|---|---|---|---|
| SITE | NBR | NBR | DESC | QTY | QTY | QTY | QTY | CODE |
| 129 | | 2693405 | | 5 | 0 | 0 | 0 | 20 |
| 129 | | 2693405 | | 6 | 0 | 6 | 0 | 20 |
| 129 | | 2693405 | | 7 | 0 | 0 | 0 | 20 |

| ORDER_BOOK_SEQ_NBR | SCAN_TIMESTAMP | LAST_POS_TIMESTAMP | DEPT_NBR | SUBCLASS_NBR | FINELINE_NBR |
|---|---|---|---|---|---|
| 0 | 2/19/2005 19:05 | 2/19/2005 0:00 | 14 | 1260 | 594 |
| 0 | 3/3/2005 16:07 | 3/2/2005 0:00 | 14 | 1260 | 594 |
| 0 | 3/2/2005 15:39 | 3/1/2005 0:00 | 14 | 1260 | 594 |

| COST_AMT | SELL_PRICE_AMT | BASE_RETAIL_AMT | PACK_QTY | MAX_SALES_FLOOR_QTY | SCAN_DATE |
|---|---|---|---|---|---|
| | | | 6 | 20 | 2/19/2005 |
| | | | | | 0:00 |
| | | | 6 | 20 | 3/3/2005 0:00 |
| | | | 6 | 20 | 3/2/2005 0:00 |

POS Data

| | Item_{—} | VNPK_{—} | Store_{—} | | Max_{—} | | Hist_On_{—} | Gross_{—} | |
|---|---|---|---|---|---|---|---|---|---|
| Item_Nbr | Flags | Qty | Nbr | WM_Week | Shelf_Qty | POS_Qty | Hand_Qty | Ship_Qty | Daily |
| 2709018 | | 6 | 129 | 200501 | 12 | 0 | 11 | 0 | Jan. 29, 2005 |
| 2709018 | | 6 | 129 | 200501 | 12 | 1 | 10 | 0 | Jan. 30, 2005 |
| 2709018 | | 6 | 129 | 200501 | 12 | 2 | 8 | 0 | Jan. 31, 2005 |
| 2709018 | | 6 | 129 | 200501 | 12 | 1 | 7 | 0 | Feb. 1, 2005 |

RFID Data

| SGTIN | SRC | Rdr_ID | Event_Time |
|---|---|---|---|
| sgtin:0037000.103776.10000000 | src:006068.0000103 | LS | 5/29/2005 19:24 |
| sgtin:0037000.103776.10000001 | src:006068.0000103 | LS | 5/28/2005 22:12 |
| sgtin:0037000.103776.10000003 | src:006068.0000103 | LS | 5/29/2005 19:24 |

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A method of evaluating out of stock conditions, comprising:
determining a minimum provable stock level relying upon RFID and non-RFID information sources.

2. The method of claim 1 wherein determining a minimum provable stock level includes evaluating out of stock conditions as a function of time, out of stock frequency, weight and accumulated weight.

3. The method of claim 1 wherein the RFID information source includes RFID information from a receiving door.

4. The method of claim 1 wherein the RFID information source includes RFID information from a salesfloor.

5. The method of claim 1 further comprising calculating a period that does not have an out of stock condition.

6. The method of claim 1 further comprising evaluating a period that is a continuation of an out of stock condition.

7. The method of claim 1 further comprising evaluating a first day out of stock episode.
